(19) United States
(12) Patent Application Publication
(10) Pub. No.: US 2006/0160981 A1
(43) Pub. Date: Jul. 20, 2006

(54) Phenolic polymer nanotube and producing the same

(76) Inventor: Tsuyoshi Kijima, Miyazaki (JP)

Correspondence Address: HARNESS, DICKEY & PIERCE, P.L.C., P.O. BOX 8910, RESTON, VA, 20195, US

(21) Appl. No.: 10/527,233

(22) PCT Filed: Mar. 5, 2003
(86) PCT No.: PCT/JP03/02603

§ 371 Date: Feb. 7, 2006

(30) Foreign Application Priority Data
Sep. 10, 2002 (JP) 2002-264771

(51) Int. Cl. C08G 61/02

(52) U.S. Cl. 528/86

(57) ABSTRACT

A phenolic polymer nanotube having a specific shape is obtained by carrying out: a reaction step in which at least one monomer selected from a group of phenol and derivative thereof is reacted with at least one aldehyde monomer in the presence of basic condensing agent; a treatment step in which a precursor obtained in the reaction step is treated with a strong base; and a polymerization step in which a reacted precursor obtained in the treatment step is dropped into aqueous solution, containing the monomer and a surfactant, so as to polymerize the reacted precursor.

### TECHNICAL FIELD

The present invention relates to (i) a novel nanotube-shape composition, having a frame component made of a phenol-aldehydic copolymer, which is used as: a high-efficiency separation material; an absorption material; a substance storage material; a biochemical component analysis microchip separation material; a DNA chip encapsulation material; a precursor of a tubular or fibrous carbon material; a molding material for manufacturing an inorganic, metallic, or polymer material whose shape is tubular, wiry, or fibrous; a molecular device; and the like, and relates to (ii) a production method thereof.

### BACKGROUND ART

It is general that polymers are roughly classified into a crystalline polymer such as polyethylene and an amorphous polymer such as polymethyl methacrylate. However, in any polymers, a texture thereof has micropores based on its composition and generation history. For example, a noncrystalline phase of the crystalline polymer and a solid component of the amorphous polymer have small-molecular-size micropores therein, and each of them is used as a gas-permeable film or as a film which shields or allows permeation of specific gas. Further, a network polymer which is a kind of the amorphous polymer and is obtained by direct polymerization of monomer or cross-linking of linear polymer swells when dipped in a solvent. This results in formation of micropores according to the degree of the cross-linking. Thus, the network polymer is used as a gel filtering material for filtering various substances, and a storage material or a slow drug, etc.

However, due to its amorphous structure, the micropores formed in the solid polymer structure or its swelling structure are uneven in terms of the size, so that micropore diameter distribution is so wide. Thus, it has been desired to create a technique in which the micropore diameter distribution in the texture of the polymer is narrowed so as to apply the polymer to highly accurate substance separation/analysis.

Meanwhile, independently or in combination with varnish dissolved in alcohol, or wood chips, die, and the like, phenol resin which is oily or solid amorphous polymer obtained by condensing phenols and aldehydes such as formaldehyde with acid or alkali is used as an adhesive, an insulative stacking plate, a decorative sheet, and the like, by using its thermosetting property. Each of them is a technique in which fluidity, adhesiveness, a thermosetting property, and a molding property of liquid or solid polymer are applied.

Further, a method of synthesizing a porous material having even nano-scale micropores has invented for the first time in an inorganic material field. In 1992, Mobile succeeded in creating meso porous silica, having honeycomb meso pores whose diameter ranges from 2 to 8 nm, by using a surfactant as a mold (see Non-patent document 1).

Thereafter, by adopting techniques similar to the foregoing technique, a large kinds of meso porous materials each of which has a frame component made of various metallic oxides and sulfides other than silica have been synthesized by the present inventors and the like (see Non-patent document 2).

Further, the present inventors produced a complex generated on the basis of a homogeneous precipitation method using urea under such condition that dodecyl sulfate ions are used as a mold, and subsequently exchanged the mold ions with acetate ions, thereby obtaining a hexagonal-structure-type rare earth oxide meso porous material (see Non-patent document 3 and Non-patent document 4).

Further, a structure having such a hollow tube that its external diameter ranges from several nm to several hundreds nm and its internal diameter ranges from several tenths nm to several dozen nm is referred to as a nanotube, and it is known that such structure is naturally occurring. An example thereof is a silicate mineral such as chrysotile, imogolite, and the like. It is reported that each of these materials has a nanotube structure. A first example of an artificial inorganic nanotube is a carbon nanotube found in 1991 as a precipitated substance on an arc electrode (see Non-patent document 5). Thereafter, there are reported an example of synthesis of nitride such as boron nitride and B-C—N and the like (see Non-patent document 6), and an example of synthesis of sulfide nanotube such as tungsten sulfide (see Non-patent document 7), molybdenum sulfide (see Non-patent document 8) and the like, all of which are based on the similar high temperature reaction.

Further, the aforementioned mold synthesis method has been applied to synthesis of the inorganic nanotube recently, and there are sequentially reported oxide nanotubes such as vanadium oxide (see Non-patent document 9), silica (Non-patent document 10), titania (see Non-patent document 11). Also the inventors of the present invention succeeded in synthesizing a rare earth oxide nanotube by expansively applying reaction conditions of the even precipitation method using urea with dodecyl sodium ions utilized as a mold (see Non-patent document 12).

Also as to organic materials, it is known to use a honeycomb structure in which cylindrical pores are disposed mainly in a hexagonal manner and to use an isolated tube structure as the nanotube structure. For example, D, L-polypeptide molecule in which D-amino acid and L-amino acid chemically bond to each other has a helically twisting β-helix structure, and has a hollow structure whose internal diameter is 0.33 nm for example (see Non-patent document 13). It is reported that also cyclic D, L-α-peptide has a honeycomb structure, made up of cylindrical units, connected to each other upward and downward on the basis of an antiparallel-β-structure hydrogen bond, whose pore diameter is 0.7 to 0.8 nm or 1,3 nm (see Non-patent documents 14 and 15). It is reported that: oligophenyl acetylene of linear molecules bends in a helical manner, and has a honeycomb structure in which cylindrical hollows each having a diameter of approximately 0.4 nm are disposed (see Non-patent document 16), and hexaphenyl acetylene of large cyclic molecules has a honycomb structure whose pore diameter is approximately 0.9 nm (see Non-patent document 17).

There is an example of synthesis to which the mold method is adopted. A sector-shaped molecule obtained by substituting an alkoxy group whose end has an added acryl group for m, m′ p of benzoic acid is made to react with benzotri imidazole so as to obtain a liquid-crystal-like meso complex. Subsequently, an alkyl chain is cross-linked by UV emission, and then a benzotri imidazole nuclear is dissolved in a methanol/hydrochloric acid mixture solution, thereby removing the benzotri imidazole nuclear. In this way, a hexagonal structure porous material in which a=3.78 nm is obtained (see Non-patent document 18). Further, meso-porous silica (Al-MCM-48) in which Al is introduced into its frame is used as a mold so as to synthesize phenol/formaldehyde resin having a micropore structure (see Non-patent document 19). Further, on the basis of a similar reaction in which a cetyl trimethyl ammonium ion aggregate serving as a cation surfactant is used as a mold, there is obtained a phenol/formaldehyde polymer complex having a layer structure and a slightly irregular hexagonal structure. However, each of these materials fails to obtain a porous structure (each of these materials is not a tubular material) (see Non-patent document 20).

Meanwhile, as an isolated nanotube, there is synthesized a tubular polymer, having cyclodextrin molecules bonding to each other in head-to-head and tail-to-tail manner, each of which has an internal diameter of 0.6 to 0.9 nm (see Non-patent document 21). After emitting an ultraviolet ray to a cylindrical micelle made of 1:2:6 triblock copolymer containing isoprene and cinnamoylethylmethacryl acid t-butylacrylic acid, isoprene serving as its central nucleus is ozonized, thereby obtaining a tube whose external diameter is 22 nm and 65 nm (internal diameter is not detailed) (see Non-patent document 22). Further, surfactant molecules whose hydrophilic group is glucose and whose hydrophobic group is long-chain phenol is made to react, thereby obtaining a fat nanotube whose internal diameter is 10 to 15 nm and external diameter is 40 to 50 nm (see Non-patent document 23).

Further, recently, the inventors of the present invention have found that: when globular particles obtained by polymerizing furfural alcohol (less graphitizable furan resin monomer) with an acid catalyst in the presence of surfactant are calcinated at a high temperature, a graphite-like carbon having a unique long-period structure and a micro alignment structure is generated, thereby finding such fact that a polymerization structure of furfural alcohol is influenced by a mold effect based on the surfactant (see Non-patent document 24).

However, most of the organic nano porous materials have a honeycomb structure in which cylindrical pores are disposed in a hexagonal manner, and an example of the isolated tube structure is extremely limited. Moreover, an internal diameter of each known organic nano porous material is not more than 1.3 nm or not less than 10 nm (including the honeycomb structure). Thus, each of the foregoing documents neither teach nor suggest an organic polymer nanotube which is in a specific range, that is, whose internal diameter is in a range more than 1.3 nm and less than 10 nm. In other words, the organic polymer nanotube having the aforementioned specific internal diameter has not been obtained yet.

Thus, the organic polymer nanotube having distribution of the specific internal diameter and a production method thereof are desired.

The present invention was made from the foregoing view point, and an object of the present invention is to provide a phenolic polymer nanotube having a specific shape and a production method thereof.

[Non-patent document 1]
C. T. Kresge and four others, Nature, 359, 710 to 712 (1992)

[Non-patent document 2]
Tsuyoshi Kijima and other, J. Soc. Inorg. Mater, 8, 3 to 16 (2001)

[Non-patent document 3]
M. Yada and three others, Inorg. Chem, 37, 6470 to 6475 (1998)

[Non-patent document 4]
M. Yada and three others, Angew. Chem. Int. Ed, 38, 3506 to 3509 (1999)

[Non-patent document 5]
S. Iijima, Nature, 364, 56 to 58 (1991)

[Non-patent document 6]
E. J. M. Hamolton and five others, Science, 260, 659 to 661 (1993)

[Non-patent document 7]
R. Tenne and three others, Nature, 360, 444 to 446 (1992)

[Non-patent document 8]
Y. Feldman and others, Science, 267, 222 to 225 (1995)

[Non-patent document 9]
M. E. Spahr and five others, Angew. Chem. Int. Ed, 37, 1263 to 1265 (1998)

[Non-patent document 10]
M. Adachi and two others, Langmuir, 15, 7097 to 7100 (1999)

[Non-patent document 11]
H. Imai and four others, J. Mater. Chem, 9, 2971 (1999)

[Non-patent document 12]
M. Yamada and four others, Adv. Mater., 14, 309 to 313 (2002)

[Non-patent document 13]
P. Desantis and others, Macromolecules, 7, 52 (1974)

[Non-patent document 14]
M. R Ghadlri and four others, Nature, 366, 324 to 327 (1993)

[Non-patent document 15]
K, Khazaomovic and others, J. J. Am. Chem. Soc., 116, 6011 (1994)

[Non-patent document 16]
J. C. Nelsom and three others, Science, 277, 1793 to 1796 (1997)

[Non-patent document 17]
D. Venkataranlan and three others, Nature, 371, 591 to 593 (1994)

[Non-patent document 18]
K. Kim and six others, Angew. Chem. Int. Ed., 40, 2669 to 2671 (2001)

[Non-patent document 19]
J. Lee and four others, Chem. Commun., 2177 (1999)

[Non-patent document 20]
I. Moriguchi and five others, Chem. Lett., 1171 to 1172 (1999)

[Non-patent document 21]
A. Harada and other, Nature, 364, 516 to 518 (1993)

[Non-patent document 22]
S. Stewart and other, Angew. Chem., Int. Ed., 39, 340 to 344 (2000)

[Non-patent document 23]
G. John and four others, Adv. Mater., 13, 715 to 718 (2001)

[Non-patent document 24]
Masashi Uota and three others, Chemical Society of Japan, the 80th autumn conference proceedings, 70 (2001)

### DISCLOSURE OF INVENTION

The inventors of the present invention conceived such an idea that a copolymerization system obtained by combining phenol with a furan monomer results in a more effective molding effect. Based on the conception, they diligently studied a monomer (furan monomer) used in the reaction, kinds of a catalyst and a surfactant, and reaction conditions in order to realize production of the polymer nanotube. As a result of the study, they found that: in polymerizing the furan monomer and aldehyde, it is possible to mildly promote the polymerization reaction by using a specific catalyst. As a result, the present invention was devised.

That is, in order to achieve the foregoing object, a phenolic polymer nanotube according to the present invention includes a copolymer which includes: at least one monomer selected from a group of phenol and derivative thereof; and at least one aldehyde monomer selected from aldehydes, wherein the phenolic polymer nanotube has an internal diameter ranging from 1.5 to 5 nm and a thickness ranging from 1.5 to 5 nm.

It is preferable to arrange the phenolic polymer nanotube according to the present invention so that: the thickness ranges from 1.5 to 2.5 nm.

It is preferable to arrange the phenolic polymer nanotube according to the present invention so that: the internal diameter ranges from 1.5 to 2.5 nm, and the thickness ranges from 3 to 5 nm.

It is preferable to arrange the phenolic polymer nanotube according to the present invention so that: a length of the phenolic polymer nanotube is 10 nm or more.

It is preferable to arrange the phenolic polymer nanotube according to the present invention so that: the phenolic polymer nanotube is used as a separation material, an absorption material, or a storage material.

It is preferable to arrange the phenolic polymer nanotube according to the present invention so that: the phenolic polymer nanotube is used as a microchip separation material for DNA chip or a protein chip.

It is preferable to arrange the phenolic polymer nanotube according to the present invention so that: the phenolic polymer nanotube is used as an encapsulation material for isolating reference single-stranded DNAs from each other.

It is preferable to arrange the phenolic polymer nanotube according to the present invention so that: the phenolic polymer nanotube is used as a precursor of a tubular or fibrous carbon material.

It is preferable to arrange the phenolic polymer nanotube according to the present invention so that: the phenolic polymer nanotube is used as a molding material for manufacturing an inorganic, metallic, or polymer material whose shape is tubular, wiry, or fibrous.

It is preferable to arrange the phenolic polymer nanotube according to the present invention so that: the phenolic polymer nanotube is used as an electronic circuit molecular device.

It is preferable to arrange the phenolic polymer nanotube according to the present invention so that: the phenolic polymer nanotube is used as a fuel battery electrolyte.

According to the foregoing arrangements, the phenolic polymer nanotube of the present invention has a frame made of a copolymer of the monomer and the aldehyde monomer, and its internal diameter ranges from 1.5 to 5 nm and its thickness ranges from 1.5 to 5 nm. Thus, due to the specific shape, the phenolic polymer nanotube of the present invention can be used for the aforementioned purposes which have not been aimed at.

In order to achieve the foregoing object, a method according to the present invention for producing the phenolic polymer nanotube includes: a reaction step in which at least one monomer selected from a group of phenol and derivative thereof is reacted with at least one aldehyde monomer selected from aldehydes in the presence of basic condensing agent; a treatment step in which a precursor obtained in the reaction step is treated with a strong base; and a polymerization step in which a reacted precursor obtained in the treatment step is dropped into aqueous solution, containing the monomer and a surfactant selected from a group of alkyl ammonium salt and alkyl amine, so as to polymerize the reacted precursor.

It is preferable to arrange the method according to the present invention for producing the phenolic polymer nanotube so that the polymerization is carried out while stirring the aqueous solution in the polymerization step.

It is preferable to arrange the method according to the present invention for producing the phenolic polymer nanotube so that the polymerization is carried out while keeping a temperature of the aqueous solution within a range of from 40 to 200° C. in the polymerization step.

According to the foregoing arrangements, the reaction step, the treatment step, and the polymerization step are carried out, so as to produce the phenolic polymer nanotube according to the present invention. Particularly, the reaction step and the treatment step cause the strong base to act, so that it is possible to mildly promote the polymerization. Thus, it is possible to produce the phenolic polymer nanotube having a unique shape.

For a fuller understanding of the nature and advantages of the invention, reference should be made to the ensuing detailed description taken in conjunction with the accompanying drawings.

### BRIEF DESCRIPTION OF DRAWINGS

FIG. 1(a) illustrates an image obtained by observing a phenolic polymer nanotube obtained in Example 1 with a transmissive electron microscope.

FIG. 1(b) illustrates an image obtained by observing a hexagonal structure, obtained in Example 2, in which a tubular structure is partially mixed, with the transmissive electron microscope.

FIG. 1(c) illustrates an image obtained by observing a phenolic polymer nanotube obtained in Example 3 with the transmissive electron microscope.

FIG. 1(d) illustrates an image obtained by observing a phenolic polymer nanotube obtained in Example 4 with the transmissive electron microscope.

FIG. 2 illustrates an X ray analysis image of the phenolic polymer nanotubes obtained in Examples 1 to 4, and “a” represents an X ray analysis image of the phenolic polymer nanotube obtained in Example 1, and “b” represents an X ray analysis image of the hexagonal structure, obtained in Example 2, in which a tubular structure is partially mixed, and “c” represents an X ray analysis image of the phenolic polymer nanotube obtained in Example 3, and “d” represents an X ray analysis image of the phenolic polymer nanotube obtained in Example 4.

FIG. 3(a) illustrates an NMR spectrum of the phenolic polymer nanotube obtained in Example 1.

FIG. 3(b) illustrates an attribution of the NMR spectrum.

FIG. 3(c) illustrates an average composition formula of the nanotube.

FIG. 4 illustrates an infrared absorption spectrum image of the phenolic polymer nanotubes obtained in Examples 1 to 4, and “a” represents an infrared absorption spectrum image of the phenolic polymer nanotube obtained in Example 1, and “b” represents an infrared absorption spectrum image of the hexagonal structure, obtained in Example 2, in which the tubular structure is partially mixed, and “c” represents an infrared absorption spectrum image of the phenolic polymer nanotube obtained in Example 3, and “d” represents an infrared absorption spectrum image of the phenolic polymer nanotube obtained in Example 4.

### BEST MODE FOR CARRYING OUT THE INVENTION

One embodiment of the present invention is described below.

Taking into consideration various reports and prior arts concerning nanotubes introduced and mentioned in BACKGROUND ART, the present invention is to provide a nanotube having a novel composition, a novel size, and a novel property which are different from those of the foregoing reports and prior arts. Particularly, its frame is made of polymer texture containing phenol as one of its main components, and it is formed in an extremely thin nanotube shape which is a specific shape, thereby providing a nanotube, having a molecule sieving property, a substance storage property, a substance transport property, a molecule encapsulation property which are peculiar to the nanotube structure, which nanotube specifically exhibits chemically, electrically, and optically superior functions derived from its electronic structure and its frame shape. Further, on this account, the present invention is to provide a novel material which contributes to technical innovations in chemical, electronic, information, environmental, biotechnology fields.

Specifically, the phenolic polymer nanotube according to the present embodiment is arranged so as to have a frame made of a copolymer including: at least one monomer selected from a group of phenol and derivative thereof; and at least one aldehyde monomer selected from aldehydes, wherein the phenolic polymer nanotube has an internal diameter ranging from 1.5 to 5 nm and a thickness ranging from 1.5 to 5 nm.

The phenol and derivative (monomer) thereof are not particularly limited as long as each of them has a phenol frame. Specific examples of the phenol and derivative thereof include phenol, 2-methylphenol (o-cresol), 3-methylphenol (m-cresol), 4-methylphenol (p-cresol), 2,3-dimethylphenol, and the like. A single kind of the phenol and derivative thereof may be used, or two or more kinds of the phenol and derivative thereof may be used.

The aldehydes (aldehyde monomer) are not particularly limited as long as a compound having an aldehyde group (—CHO) is used as the aldehyde monomer. Specific examples of the aldehydes include furfural, formaldehyde, acetaldehyde, acrylic aldehyde, benzaldehyde, and the like. A single kind of the aldehydes may be used, or two or more kinds of the aldehydes may be used. Of the aldehydes exemplified above, it is more preferable to use furfural in terms of easiness to form the tubular structure.

The phenolic polymer nanotube according to the present embodiment has a frame made of a copolymer including: at least one monomer selected from a group of phenol and derivative thereof; and at least one aldehyde monomer selected from aldehydes. Further, its internal diameter ranges from 1.5 to 5 nm and its thickness ranges from 1.5 to 5 nm.

A lower limit of the internal diameter of the phenolic polymer nanotube is preferably not less than 1.5 nm, more preferably not less than 2 nm. While, an upper limit of the internal diameter of the phenolic polymer nanotube is preferably not more than 5 nm, more preferably not more than 3 nm.

Note that, a preferable internal diameter of the phenolic polymer nanotube varies depending on use thereof. Specifically, for example, the internal diameter preferably ranges from 3 to 5 nm in separating proteins. For example, in collecting nonyl phenol which is one of endocrine disrupters, the internal diameter more preferably ranges from 2 to 3 nm. Further, the internal diameter can be changed within a range of from 2 to 5 nm by changing a length of the surfactant or by adding a swelling agent.

Further, a lower limit of the thickness of the phenolic polymer nanotube is preferably not less than 1.5 nm, more preferably not less than 2 nm. In case where the lower limit is less than 1.5 nm, its strength drops, so that such arrangement is not preferable. While, an upper limit of the thickness of the phenolic polymer nanotube is preferably not more than 5 nm, more preferably not more than 3 nm.

Further, the length of the phenolic polymer nanotube more preferably ranges from 1.5 to 3 nm in terms of a utilization ratio of a material. However, the preferable length of the phenolic polymer nanotube varies depending on use thereof, and is not particularly limited. Specifically, in case of separation or collection for example, the length is more preferably not less than 10 nm in order to sufficiently exhibit a separation ability and the like. In case of transporting substances for example, the length is more preferably not less than 100 nm.

A method according to the present embodiment for producing the phenolic polymer nanotube includes: a reaction step in which at least one monomer selected from a group of phenol and derivative thereof is reacted with at least one aldehyde monomer selected from aldehydes in the presence of basic condensing agent; a treatment step in which a precursor obtained in the reaction step is treated with a strong base; and a polymerization step in which a reacted precursor obtained in the treatment step is dropped into aqueous solution, containing the monomer and at least one surfactant selected from a group of alkyl ammonium salt and alkyl amine, so as to polymerize the reacted precursor.

In the reaction step, at least one monomer selected from a group of phenol and derivative thereof (i.e., phenols) and at least one aldehyde monomer selected from aldehydes are polymerized in the presence of a basic condensing agent.

Specific examples of the basic condensing agent include ammonium hydroxide, potassium hydroxide, tetramethyl ammonium hydroxide, and the like. Of the basic condensing agents exemplified above, it is more preferable to use sodium hydroxide since sodium hydroxide is hardly precipitated as alkali salt. One kind of the basic condensing agent may be used, or two or more kinds of the basic condensing agent may be used.

As to a mixture ratio of the monomer and the aldehyde monomer, it is more preferable to mix 1 mol of the monomer with 1 to 3 mol of the aldehyde monomer, and it is particularly preferable to mix 1 mol of the monomer with 2 mol of the aldehyde monomer.

Further, as to an amount of the added basic condensing agent, it is preferable to mix 1 mol of the monomer with 0.01 to 0.1 mol of the basic condensing agent, and it is particularly preferable to add 0.05 mol of the basic condensing agent.

By adding and mixing the monomer, the aldehyde monomer, and the basic condensing agent, whose molarities are within the foregoing ranges, with each other so as to carry out the reaction thereof, it is possible to mildly promote the reaction, so that it is possible to obtain an oligomer whose polymerization degree is relatively low. That is, in the reaction step, a phenol (monomer) and an aldehyde (aldehyde monomer) are polymerized in the presence of the basic condensing agent (alkaline catalyst), so that the polymerization reaction is mildly promoted, thereby generating an oligomer whose polymerization degree is relatively low. On this account, it is possible to favorably control the internal diameter (pore diameter) and the thickness of a finally obtained phenolic polymer nanotube. Note that, in the reaction step, when the monomer and the aldehyde monomer are copolymerized in the presence of an acidic condensing agent (acidic catalyst), the polymerization reaction is rapidly promoted, so that a solid polymer whose polymerization degree is high is generated. Even when the resultant is treated in the same manner, the nanotube is not generated, so that such arrangement is not preferable.

A reaction condition in the reaction step is described as follows. In carrying out the reaction, it is more preferable to carry out the reaction while stirring the solution. Further, a reaction temperature is more preferably within a temperature range of from 40 to 100° C., further more preferably 80° C. A time taken to carry out the reaction more preferably ranges from 5 to 20 hours, further more preferably 15 hours.

In the treatment step, the oligomer (precursor), obtained in the reaction step, whose polymerization degree is low, is treated with the strong base, thereby obtaining an reacted precursor. Specifically, the strong base is added to liquid oligomer obtained in the reaction step, so that a hydroxyl group bonding to an aromatic ring constituting the oligomer is made anionic.

A specific example of the strong base used in the treatment step is the basic condensing agent exemplified in the reaction step. In case of using a sodium hydroxide aqueous solution using sodium hydroxide as the strong base for example, its concentration more preferably ranges from 1 mol/l to 5 mol/l. Note that, the basic condensing agent used in the reaction step may be used as the strong base used here, or other agent may be used as the strong base used here.

It is more preferable to change an amount of the strong base added in the treatment step depending on types of materials (monomer, aldehyde monomer). Specifically, in case of phenol furfurals using a phenol as the monomer and using a furfural as the aldehyde monomer, a total amount of the basic condensing agent used in the reaction step and the strong base added in the treatment step more preferably ranges from 90 to 100 mol % with respect to an amount of the monomer. It is particularly preferable to add the strong base so that both of them are equal with each other in terms of mol. Further, in case of phenol formaldehydes using a phenol as the monomer and using a formaldehyde as the aldehyde monomer, a total amount of the basic condensing agent used in the reaction step and the strong base added in the treatment step more preferably ranges from 70 to 80 mol % with respect to an amount of the monomer. It is particularly preferable to add the strong base so that the total amount is approximately 75 mol %. Note that, in case where an acidic group such as a sulfo group is introduced into the monomer as a substitutional group in advance, it is more preferable to further add the strong base whose amount neutralizes the acidic group.

In the reaction system, the strong base whose molarity is in the foregoing range is added, so that (i) it is possible to prevent the monomer added in the polymerization step described later from being anionic, thereby preventing inhibition of the polymerization reaction, and (ii) it is possible to favorably form a nanotube structure by slightly dropping electric charge density of the oligomer.

In the polymerization step, the reacted precursor obtained in the treatment step is dropped into a mixture solution of the monomer, the surfactant, and water, and is polymerized, thereby obtaining the phenolic polymer nanotube according to the present invention. The surfactant is used in the polymerization step, so that the surfactant serves as a molding component, thereby obtaining a tubular structure. Specifically, the reacted precursor and the monomer added in the polymerization step gather in the vicinity of a styloid micelle of the surfactant and polymerize, so that the tubular structure is obtained.

As the monomer used in the polymerization step, it is more preferable to use a monomer which is the same as the monomer contained in the reacted precursor. However, it is not necessary that the monomer used in the polymerization step is the same monomer as the monomer contained in the reacted precursor. In the polymerization step, the same monomer as the monomer used in the reaction step is used, so that it is possible to promote copolymerization of three components: the anionic oligomer contained in the reacted precursor; a remaining aldehyde monomer which has not reacted in the reaction step; and a newly added monomer (phenols), thereby obtaining a solid polymer. Further, when an amount of the molding component (surfactant) contained in the mixture solution is excessive, generation of the hexagonal structure is promoted, so that it is necessary to set the amount of added molding component at a low level. Note that, the amount of the surfactant used will be described later.

A specific example of the surfactant is alkyl ammonium salt or alkyl amine. Examples of alkyl ammonium salt include cetyl trimethyl ammonium chloride, dodecyl trimethyl ammonium bromide, and the like. Further, examples of alkyl amine include cetyl amine, dodecyl amine, and the like.

Amounts of the monomer, the surfactant, and water that are used in the polymerization step are described as follows. The amount of the monomer used in the polymerization step more preferably ranges from 0.1 to 0.2 mol, and is particularly preferably 0.15 mol, with respect to 1 mol of the monomer used in the reaction step (for example, phenol). Further, the amount of the surfactant (for example, cetyl trimethyl ammonium bromide) more preferably ranges from 0.05 to 1 mol, and is particularly preferably 0.1 mol, with respect to 1 mol of the monomer used in the reaction step. Further, the amount of water more preferably ranges from 50 to 100 mol, and is particularly preferably 80 mol, with respect to 1 mol of the monomer used in the reaction step. That is, it is more preferable to drop a solution containing the reacted precursor into a mixture solution having such a molar ratio that monomer:surfactant:water=0.1 to 0.2:0.05 to 1:50 to 100 with respect to 1 mol of the monomer used in the reaction step.

A polymerization condition of the polymerization step is described as follows. A lower limit of a polymerization temperature is more preferably 40° C. or higher, further more preferably 60° C. or higher, particularly preferably 80° C. or higher. In case where the polymerization temperature is lower than 40° C., the polymerization is insufficiently carried out, so that there is a possibility that the desired nanotube structure cannot be obtained. While, an upper limit of the polymerization temperature is more preferably 200° C. or lower, further more preferably 140° C. or lower, particularly preferably 100° C. or lower. In case where the polymerization temperature is higher than 200° C., the reacted precursor may be decomposed. Note that, the polymerization step may be carried out under a pressure condition. The pressure condition is accordingly set depending on types and amounts of the monomer, the aldehyde monomer, and the surfactant, that are used in the polymerization step.

Further, a time taken to carry out the polymerization more preferably ranges from 1 to 20 hours, further more preferably ranges from 6 to 20 hours.

In the polymerization step, the reacted precursor is dropped into the mixture solution made of the monomer, the surfactant, and water, and then the polymerization is carried out while stirring the aqueous solution, that is, the mixture solution containing the reacted precursor, so that it is possible to obtain the phenolic polymer nanotube whose internal diameter is relatively large and thickness is thin. The condition “while stirring the aqueous solution” means that: for example, a machine such as a magnetic stirrer which can strongly stir solution is used so as to evenly stir the aqueous solution more preferably at 100 rpm or higher, further more preferably 500 rpm or higher. The polymerization reaction is carried out while stirring the aqueous solution at 80° C. or higher and under the foregoing condition, thereby obtaining a phenolic polymer nanotube whose both ends are open. Specifically, it is possible to obtain the phenolic polymer nanotube whose internal diameter substantially ranges from 1.5 to 5 nm and thickness substantially ranges from 1.5 to 2.5 nm.

While, in the polymerization step, the reacted precursor is dropped into the mixture solution made of the monomer, the surfactant, and water, and then the polymerization is carried out while not stirring the aqueous solution, that is, the aqueous solution containing the reacted precursor, thereby obtaining the phenolic polymer nanotube, whose internal diameter is relatively large and thickness. Specifically, for example, it is possible to obtain the phenolic polymer nanotube, having an internal diameter substantially ranging from 1.5 to 2.5 nm and a thickness substantially ranging from 1.5 to 2.5 nm, in which at least one of its both ends is closed. In case where the stirring operation is not carried out, the reacted precursor is excessively supplied to the vicinity of a styloid micelle which serves as a mold (surfactant) in the mixture solution, so that a thickness of the tubular structure is thicker, thereby obtaining a tube whose end is closed.

Note that, a preliminary polymerization step may be carried out before carrying out the polymerization step. The preliminary polymerization means a step of carrying out the polymerization at a temperature lower than the polymerization temperature at which the polymerization is carried out in the polymerization step.

A solid product obtained in this manner is centrifuged, rinsed, and dried under reduced pressure, thereby producing the phenolic polymer nanotube according to the present invention.

As described above, the phenolic polymer nanotube according to the present embodiment is a nanotube, having a specific size, whose frame component is a copolymer made of one or more kinds of monomer (phenols) or derivative thereof and one or more kinds of aldehyde monomer (aldehydes), wherein there are various combinations of the phenols and the aldehydes in terms of a composition. Further, it may be so arranged that: other substitutional group or the like is introduced into the monomer on the basis of an addition reaction or the like, and then the foregoing steps are carried out, so as to produce the phenolic polymer nanotube. Further, it may be so arranged that: other substitutional group is introduced into a frame texture of the obtained phenolic polymer nanotube by carrying out an addition reaction or the like.

Further, the method according to the present embodiment for producing the phenolic polymer nanotube is arranged so that: a copolymer (precursor), obtained by reacting one or more kinds of monomer (phenols) with one or more kinds of aldehyde monomer (aldehydes) in the presence of a basic condensing agent (alkaline catalyst), whose polymerization degree is low, is made ionic with strong alkali (strong base), and then is added to the aqueous solution containing one or more kinds of the monomer and one kind of surfactant, and a polymerization reaction is carried out in the presence of a mold (surfactant), so as to derive a nanotube having a specific size. Thus, an optimum reaction temperature and a reaction mixture composition at each stage for constructing the nanotube vary depending on a kind of the desired monomer and properties of the surfactant used.

The phenolic polymer nanotube according to the present embodiment has various useful functions such as: superior molecular sieving; substance separation; substance transport; substance storage; ion conduction; an electric conduction or electric insulation property; a selective absorption property; and the like, all of which result from (i) a unique shape and micropores as a polymer tube and (ii) a component bonding property such as conjugate double bond. Further, by causing the phenolic polymer nanotube according to the present embodiment to exhibit these useful functions, it is possible to use the phenolic polymer nanotube for industrially, medically, and biotechnically important purposes such as: a high-efficiency separation material; an absorption material; a substance storage material; a biochemical component analysis microchip separation material; a DNA chip DNA encapsulation material; a precursor of a tubular or fibrous carbon material; a molding material for manufacturing an inorganic, metallic, or polymer material whose shape is tubular, wiry, or fibrous; a molecular device; a fuel battery electrolyte; and the like.

Specifically, in case where the phenolic polymer nanotube according to the present embodiment is used as a substance separation material, only molecules and ions each of which is smaller than the internal diameter (for example, an internal diameter ranging from 2 to 4 nm) of the nanotube are allowed to enter therein, so that it is possible to easily separate relatively small substances such as endocrine disrupters (nonyl phenyl, phthalate ester, and the like) and amino acid from high molecular substances such as proteins.

Further, in case where the polymer nanotube is used as a chemical chip separation material, only molecules and ions each of which is smaller than the internal diameter (for example, an internal diameter ranging from 2 to 4 nm) of the nanotube are allowed to enter therein, so that it is possible to effectively and efficiently separate chemical components such as DNAs, proteins, or other blood constituents. Thus, it is possible to realize a high-efficiency microchip such as a protein chip for analyzing a large quantity of test substances containing these components at once.

Further, in case where the polymer nanotube is used as an encapsulation material for reference single-stranded DNAs in a DNA chip for analyzing DNA components, the reference single-stranded DNAs are isolated from each other for each reference molecular strand on the basis of the internal diameter (for example, an internal diameter ranging from 2 to 4 nm) of the nanotube, so that it is possible to integrate the reference single-stranded DNAs in a high-density manner. Moreover, the analysis is free from any uncertainty caused by adjacent DNAs, so that it is possible to carry out the identification with extremely high accuracy.

Further, in case where the polymer nanotube is used as a substance storage material, it is possible to effectively store relatively large molecules such as DNAs and small molecules and ions such as hydrogen each of which is smaller than the internal diameter (for example, an internal diameter ranging from 2 to 4 nm) of the nanotube.

Further, in case where the polymer nanotube is used as a precursor of a carbon material, due to its fine and unique shape, it is possible to manufacture a novel carbon material whose shape is tubular, wiry, or fibrous.

Further, in case where the polymer nanotube is used as a molding material, due to its fine and unique shape, it is possible to manufacture an inorganic, metallic, or polymer material whose shape is tubular, wiry, or fibrous.

Further, in case where the polymer nanotube is used as an electronic circuit element, due to its fine shape and electric conductivity caused by bonding conjugation, the polymer nanotube can function as a super-high-integrated electronic circuit molecular device.

Further, in case where a substitutional group such as a sulfo group is introduced into the polymer nanotube and the resultant is used as an electrolyte, a conduction path of protons is formed along an internal wall surface of the nanotube structure, so that the polymer nanotube can exhibit a function as a fuel battery electrolyte.

Thus, the structure of the phenolic polymer nanotube of the present invention which has an internal diameter of 1.5 to 5 nm and a thickness of 1.5 to 5 nm and a length of 10 nm or more is essentially different from conventional arts concerning an organic nano madreporite.

### EXAMPLES

The present invention is detailed by the following examples and comparative examples, but the present invention is not limited to the examples and comparative examples.

### Example 1

Phenol, furfural, and sodium hydroxide were mixed with each other at a molar ratio of 1:2:0.05, and a resultant was reacted at 80° C. for 15 hours while stirring the resultant (reaction step).

Further, 5 mol/l sodium hydroxide aqueous solution was added to mixture solution of thus obtained solute product (precursor) (treatment step). An amount of the added sodium hydroxide aqueous solution was adjusted so that a total molar quantity of sodium hydroxide contained in the mixture solution and a molar quantity of phenol are equal to each other, thereby obtaining a solution containing a reacted precursor.

Next, the solution containing the reacted precursor was dropped into a mixture solution obtained by mixing phenol, cetyl trimethyl ammonium bromide (CTAB), and water so that a molar ratio thereof was 0.15:0.1:80, thereby obtaining a reaction solution whose molar ratio of phenol, furfural, CTAB, and water was 1.15:2:0.1:90.6. Further, the reaction solution was reacted at 80° C. for six hours while stirring the reaction solution (polymerization step).

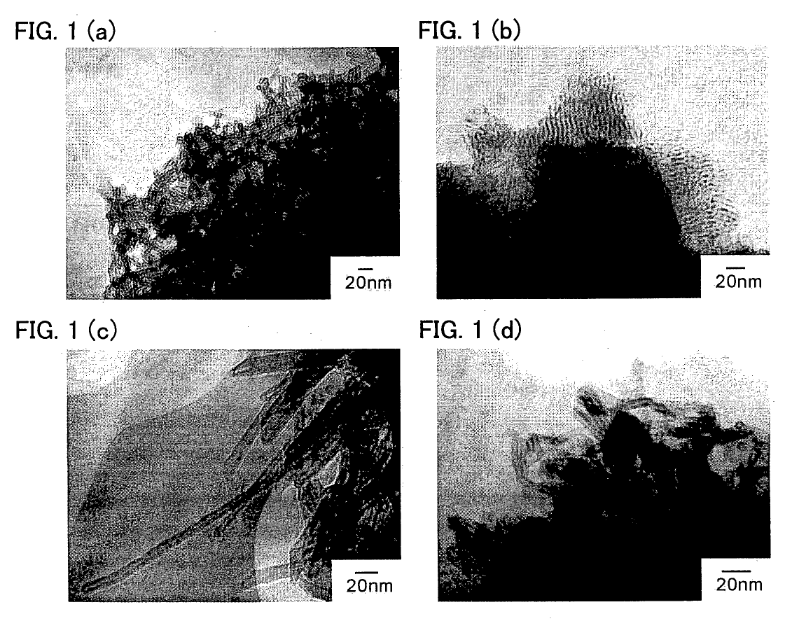

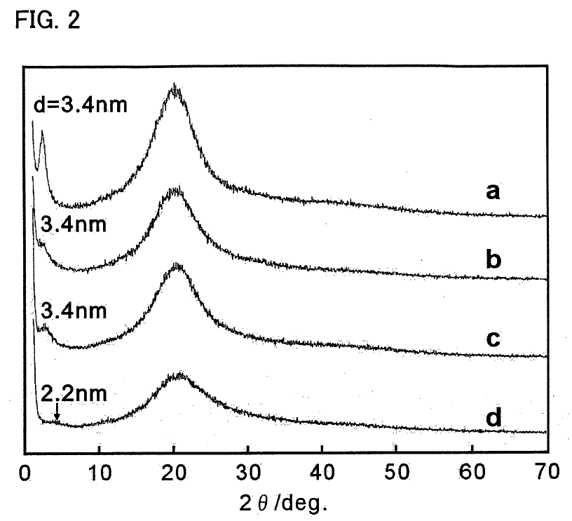

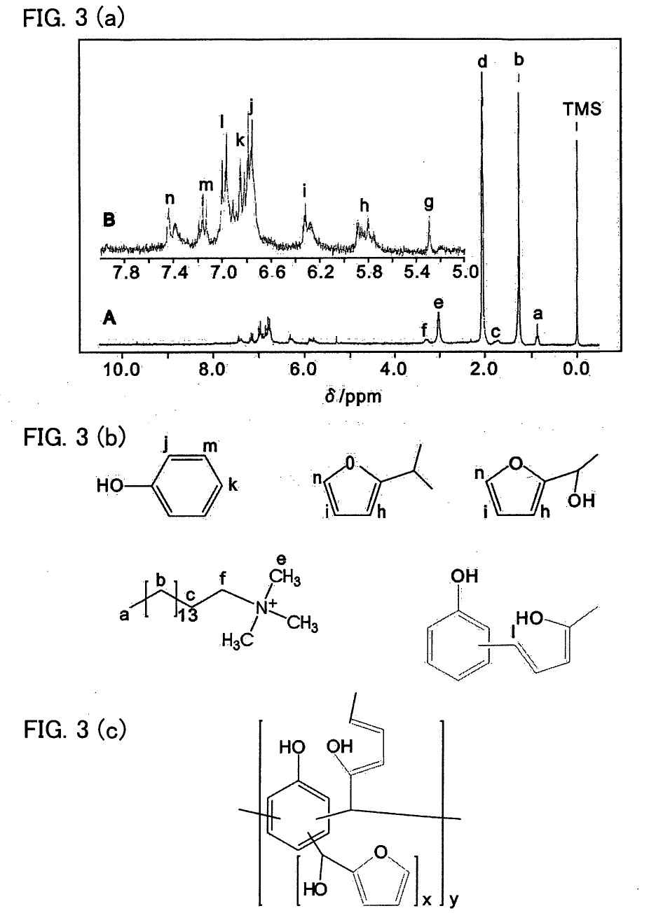

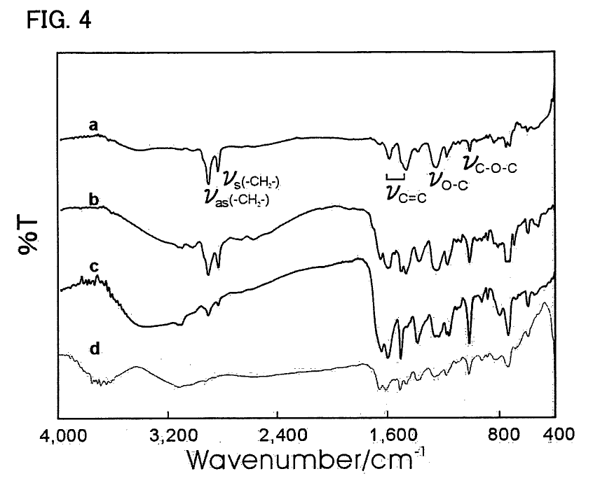

After being centrifuged, thus obtained solid phase was rinsed and dried under reduced pressure, thereby obtaining a solid product (hereinafter, referred to as 80° C.-product). Thus obtained 80° C.-product was observed with a transmissive electron microscope. As a result of the observation, it was found that a main phase of the 80° C.-product was tubular particles each of which has an external diameter of approximately 6 nm and an internal diameter of approximately 3 nm (see FIG. 1(a)). Further, an XDR pattern of the 80° C.-product shows that: a nanotube structure grew instead of a hexagonal structure having no tubular structure, a peak of d=3.4 nm which was characteristic to the hexagonal structure was almost lost, and a tubular structure was formed (“b” of FIG. 2). Further, the 80° C.-product gives an NMR spectrum illustrated in FIG. 3(a) and signals “a” to “k” of the NMR spectrum respectively attribute to protons illustrated in FIG. 3(b). When it is assumed that an average frame composition of the product is as illustrated in FIG. 3(c), such estimation that x=0.5 was obtained. Further, the 80° C.-product contained 0.18 mol of cetyl trimethyl ammonium (surfactant) with respect to 1 mol of phenol, and existence of a cetyl trimethyl ammonium component was confirmed also by an infrared absorption spectrum (“b” of FIG. 4). This shows that the phenolic polymer nanotube according to the present invention was obtained.

### Example 2

The same operation as Example 1 was carried out except that the polymerization step was carried out at 40° C., thereby obtaining a solid product (hereinafter, referred to as 40° C.-product). Further, the 40° C.-product was observed with a transmissive electron microscope. As a result of the observation, it was confirmed that: the 40° C.-product was a mixture in which a tubular structure was partially mixed in a hexagonal structure which was a main product (see FIG. 1(b)). Further, a large part of the obtained solid product was a hexagonal structure, so that a long-period peak of d=3.4 nm corresponding to 100 diffractive lines of the hexagonal structure whose lattice constant was a=3.9 nm was obtained in its XRD diffraction pattern (“a” of FIG. 2).

### Example 3

While being stirred, a reacted precursor solution prepared by the same procedure (reaction step and treatment step) under the same condition as Example 1 was dropped into a mixture solution obtained by mixing phenol, cetyl trimethyl ammonium bromide (CTAB), and water so that a molar ratio thereof was 0.15:0.1:80, thereby obtaining a reaction mixture whose total molar ratio of phenol, furfural, CTAB, and water was 1.15:2:0.1:90. 6. Thereafter, the reaction mixture was reacted at 103° C. for 6 hours without being stirred.

Thus obtained solid phase was centrifuged, rinsed, and dried under reduced pressure, thereby obtaining a solid product (hereinafter, referred to as 103° C.-product). The 103° C.-product was observed with a transmissive electron microscope. The observation shows that: end-closed-type tubular particles whose average external diameter was 10 nm and internal diameter was approximately 2 nm and thickness was approximately 4 nm were a main phase (see FIG. 1(c)). This can be confirmed also from such fact that: a peak of d=3.4 nm derived from a hexagonal structure whose lattice constant was a=3.9 nm was extremely slight in an XDR diffraction pattern of the 103° C.-product (“c” of FIG. 2). That is, a large part thereof was a tubular structure. Further, a fact that infrared absorption strength attributed to a cetyl trimethyl ammonium component extremely dropped (“c” of FIG. 4) shows that also a content of the surfactant decreased corresponding to increase of the thickness of the tubular structure. This shows that the phenolic polymer nanotube according to the present invention was obtained.

### Example 4

Cetyl amine was used as the surfactant instead of using cetyl trimethyl ammonium bromide, and a polymerization reaction of phenol-furfurals was carried out by the same procedure (reaction step, treatment step, and polymerization step), at the same material mixture ratio, at the same reaction temperature, for the same reaction time as Example 1, thereby obtaining a solid product (cetyl-amine-80° C.-product). The cetyl-amine-80° C.-product was observed with a transmissive electron microscope. The observation shows that: a main phase of the cetyl-amine-80° C.-product was tubular particles each of which has an external diameter of approximately 6 nm and an internal diameter of approximately 3 nm (see FIG. 1(d)). This can be confirmed also from such fact that: a peak of d=2.2 nm derived from a hexagonal structure whose lattice constant was a=2.5 nm was extremely slight in an XDR diffraction pattern of the cetyl-amine-80° C.-product (“d” of FIG. 2). Moreover, no absorption attributed to a cetyl trimethyl ammonium component was found in its infrared absorption spectrum (“d” of FIG. 4). This shows that thus obtained solid product was a hollow nanotube containing no surfactant component as a mold. This shows that the phenolic polymer nanotube according to the present invention was obtained.

### Example 5

Phenol, formaldehyde, and sodium hydroxide were mixed with each other at such a molar ratio that 1:2:0.2, and thus obtained mixture was reacted at 80° C. for two hours while being stirred. Thereafter, 5M sodium hydroxide aqueous solution was added to thus obtained solute product. An amount of the solution added was adjusted so that a total molar quantity of sodium hydroxide contained in the mixture solution was 0.75 mol with respect to 1 mol of phenol. Subsequently, the reacted precursor solution was dropped into a mixture aqueous solution obtained by mixing phenol, cetyl trimethyl ammonium bromide (CTAB), and water so that a molar ratio thereof was 0.15:0.1:80, thereby obtaining a reaction mixture whose total molar ratio of phenol, formaldehyde, CTAB, and water was 1.15:2:0.1:86.1. While being stirred, the reaction mixture was subjected to a preliminary reaction at 40° C. for one hour. Thereafter, the resultant was reacted at 80° C. for 6 hours. Thus obtained solid phase was centrifuged, rinsed, and dried under reduced pressure, thereby obtaining a solid product. In an XRD diffraction pattern thereof (not shown), a peak of d=3.6 nm corresponding to 100 diffractive lines of a hexagonal structure whose lattice constant was a=4.2 nm was found. Further, the solid product was observed with a transmissive electron microscope. In the observation, it was confirmed that the solid product was a mixture of (i) tubular particles each of which has an external diameter of approximately 6 mm and an internal diameter of approximately 3 nm and (ii) a hexagonal structure. Further, this shows that the phenolic polymer nanotube according to the present invention was obtained.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable to: a high-efficiency separation material; an absorption material; a substance storage material; a biochemical component analysis microchip separation material; a DNA chip DNA encapsulation material; a precursor of a tubular or fibrous carbon material; a molding material for manufacturing an inorganic, metallic, or polymer material whose shape is tubular, wiry, or fibrous; a molecular device; a fuel battery; and the like.

1. A phenolic polymer nanotube, comprising a copolymer which includes: at least one monomer selected from a group of phenol and derivative thereof; and at least one aldehyde monomer selected from aldehydes, wherein
the phenolic polymer nanotube has an internal diameter ranging from 1.5 to 5 nm and a thickness ranging from 1.5 to 5 nm.

2. The phenolic polymer nanotube as set forth in claim 1, wherein the thickness ranges from 1.5 to 2.5 nm.

3. The phenolic polymer nanotube as set forth in claim 1, wherein the internal diameter ranges from 1.5 to 2.5 nm, and the thickness ranges from 3 to 5 nm, and at least one of both ends of the phenolic polymer nanotube is closed.

4. The phenolic polymer nanotube as set forth in claim 1, wherein a length of the phenolic polymer nanotube is 10 nm or more.

5. The phenolic polymer nanotube as set forth in claim 1, wherein the phenolic polymer nanotube is used as a separation material, an absorption material, or a storage material.

6. The phenolic polymer nanotube as set forth in claim 1, wherein the phenolic polymer nanotube is used as a microchip separation material for DNA chip or a protein chip.

7. The phenolic polymer nanotube as set forth in claim 1, wherein the phenolic polymer nanotube is used as an encapsulation material for isolating reference single-stranded DNAs from each other.

8. The phenolic polymer nanotube as set forth claim 1, wherein the phenolic polymer nanotube is used as a precursor of a tubular or fibrous carbon material.

9. The phenolic polymer nanotube as set forth in claim 1, wherein the phenolic polymer nanotube is used as a molding material for manufacturing an inorganic, metallic, or polymer material whose shape is tubular, wiry, or fibrous.

10. The phenolic polymer nanotube as set forth in claim 1, wherein the phenolic polymer nanotube is used as an electronic circuit molecular device.

11. The phenolic polymer nanotube as set forth in claim 1, wherein the phenolic polymer nanotube is used as a fuel battery electrolyte.

12. A method of producing a phenolic polymer nanotube, comprising:
a reaction step in which at least one monomer selected from a group of phenol and derivative thereof is reacted with at least one aldehyde monomer selected from aldehydes in the presence of basic condensing agent;
a treatment step in which a precursor obtained in the reaction step is treated with a strong base; and
a polymerization step in which a reacted precursor obtained in the treatment step is dropped into aqueous solution, containing the monomer and a surfactant selected from a group of alkyl ammonium salt and alkyl amine, so as to polymerize the reacted precursor.

13. The method as set forth in claim 12, wherein the polymerization is carried out while stirring the aqueous solution in the polymerization step.

14. The method as set forth in claim 12 or 13, wherein the polymerization is carried out while keeping a temperature of the aqueous solution within a range of from 40 to 200° C. in the polymerization step.
